(19) United States
(12) Patent Application Publication
(10) Pub. No.: US 2026/0230643 A1
(43) Pub. Date: Aug. 6, 2026

(54) A METHOD, AN APPARATUS AND A COMPUTER PROGRAM PRODUCT FOR VIDEO ENCODING AND DECODING

(71) Applicant: Nokia Technologies Oy, Espoo (FI)

(72) Inventors: Pekka ASTOLA, Tampere (FI); Ramin GHAZNAVI YOUVALARI, Tampere (FI)

(21) Appl. No.: 19/153,103

(22) PCT Filed: Jan. 23, 2024
(86) PCT No.: PCT/FI2024/050025

§ 371 Date: Aug. 1, 2025

(30) Foreign Application Priority Data
Feb. 27, 2023 (FI) 20235230

(51) Int. Cl. H04N 19/593; H04N 19/105; H04N 19/176

(52) U.S. Cl. CPC H04N 19/593; H04N 19/105; H04N 19/176

(57) ABSTRACT

A method comprises processing (1410) a video frame; searching (1420) for a set of candidate blocks for prediction of a current block of the video frame; deriving (1430) bi-weighting parameters; determining (1440) a set of templates for the candidate blocks; determining (1450) a set of predictions for the current block based on prediction being applied on said set of templates and the derived bi-weighting parameters; determining (1460) a best prediction from the set of predictions by minimizing an error between a template to which prediction was applied and a template of the current block; using (1470) bi-weighted merge of the blocks corresponding to the templates providing the best prediction to predict the current block; and signaling (1480) the use of a bi-weighted prediction. The present embodiments also relate to technical equipment for implementing the method.

### TECHNICAL FIELD

The present solution generally relates to video encoding and video decoding. In particular, the present solution relates to determining a set of filter parameter used in encoding/decoding.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

A video coding system may comprise an encoder that transforms an input video into a compressed representation suited for storage/transmission and a decoder that can uncompress the compressed video representation back into a viewable form. The encoder may discard some information in the original video sequence in order to represent the video in a more compact form, for example, to enable the storage/transmission of the video information at a lower bitrate than otherwise might be needed.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided an apparatus comprising means for processing a video frame; means for searching for a set of candidate blocks for prediction of a current block of the video frame; means for deriving bi-weighting parameters; means for determining a set of templates for the candidate blocks; means for determining a set of predictions for the current block based on prediction being applied on said set of templates and the derived bi-weighting parameters; means for determining a best prediction from the set of predictions by minimizing an error between a template to which prediction was applied and a template of the current block; means for using bi-weighted merge of the blocks corresponding to the templates providing the best prediction to predict the current block; and means for signaling the use of a bi-weighted prediction.

According to a second aspect, there is provided a method, comprising processing a video frame; searching for a set of candidate blocks for prediction of a current block of the video frame; deriving bi-weighting parameters; determining a set of templates for the candidate blocks; determining a set of predictions for the current block based on prediction being applied on said set of templates and the derived bi-weighting parameters; determining a best prediction from the set of predictions by minimizing an error between a template to which prediction was applied and a template of the current block; using bi-weighted merge of the blocks corresponding to the templates providing the best prediction to predict the current block; and signaling the use of a bi-weighted prediction.

According to a third aspect, there is provided an apparatus comprising at least one processor, memory including computer program code, the memory and the computer program code configured to, with the at least one processor, cause the apparatus to perform at least the following: process a video frame; search for a set of candidate blocks for prediction of a current block of the video frame; deriving bi-weighting parameters; determine a set of templates for the candidate blocks; determine a set of predictions for the current block based on prediction being applied on said set of templates and the derived bi-weighting parameters; determine a best prediction from the set of predictions by minimizing an error between a template to which prediction was applied and a template of the current block; use bi-weighted merge of the blocks corresponding to the templates providing the best prediction to predict the current block; and signal the use of a bi-weighted prediction.

According to a fourth aspect, there is provided computer program product comprising computer program code configured to, when executed on at least one processor, cause an apparatus or a system to: process a video frame; search for a set of candidate blocks for prediction of a current block of the video frame; deriving bi-weighting parameters; determine a set of templates for the candidate blocks; determine a set of predictions for the current block based on prediction being applied on said set of templates and the derived bi-weighting parameters; determine a best prediction from the set of predictions by minimizing an error between a template to which prediction was applied and a template of the current block; use bi-weighted merge of the blocks corresponding to the templates providing the best prediction to predict the current block; and signal the use of a bi-weighted prediction.

According to an embodiment, the candidate blocks are searched from a reconstructed part of the current frame.

According to an embodiment, the candidate blocks, and the current block have an L-shaped template.

According to an embodiment, the set of candidate blocks comprises two or more reconstructed intra blocks.

According to an embodiment, when the set of candidate blocks comprise more than two reconstructed intra blocks, the apparatus comprises means for merging the more than two reconstructed intra blocks.

According to an embodiment, each candidate block in a set of candidate blocks is filtered.

According to an embodiment, a use of filtering is signaled at coding unit, prediction unit, coding tree unit, slice, frame, sequence level.

According to an embodiment, the use of bi-weighted prediction is signaled at coding unit, prediction unit, coding tree unit, slice, frame, sequence level.

According to an embodiment, the bi-weighting parameters are derived in a recursive manner.

According to an embodiment, a number of candidate blocks to merge in recursive manner is signaled at coding unit, prediction unit, coding tree unit, slice, frame, sequence.

According to an embodiment, a use of recursive search is signaled at coding unit, prediction unit, coding tree unit, slice, frame, sequence level.

According to an embodiment, a number of recursions is signaled at coding unit, prediction unit, coding tree unit, slice, frame, sequence level.

According to an embodiment, the bi-weighting parameters are derived by a multi-model variant where a set of parameters is obtained for a sample value interval.

According to an embodiment, a use of multi-model variant is signaled at coding unit, prediction unit, coding tree unit, slice, frame, sequence level.

According to an embodiment, the computer program product is embodied on a non-transitory computer readable medium.

### DESCRIPTION OF THE DRAWINGS

In the following, various embodiments will be described in more detail with reference to the appended drawings, in which

FIG. 1 shows an example of the location of the left and above samples of a current block involved in the CCLM mode.

FIG. 2a shows an example of derivation of chroma prediction mode from luma mode when CCLM is enabled.

FIG. 2b shows an example of a unified binarization table for chroma prediction mode.

FIG. 3a shows two luma-to-chrome models obtained for luma Y threshold of 17.

FIG. 3b shows an example of correspondence of each luma-to-chroma model to a spatial segmentation of the content.

FIG. 4 shows an example of locations of the samples used for the derivation of CCCM filter.

FIG. 5 shows examples of various filter kernels;

FIG. 6 shows an example of four reference lines neighboring to a prediction block.

FIG. 7 shows an example an example of matrix weighted intra prediction process.

FIG. 8 shows an example of HoG computation from a template of width 3 pixels.

FIG. 9 shows an example of a low-frequency Non-Separable Transform (LFNST) process.

FIG. 10 shows an example of intra template matching search area used;

FIG. 11 shows an example of IBC reference region depending on current CU position;

FIG. 12 shows an example of reference area for IBC when CTU (m, n) is coded.

FIGS. 13a, 13b show an example of BV adjustment for horizontal flip and vertical flip;

FIG. 14 is a flowchart illustrating a method according to an embodiment.

FIG. 15 shows an apparatus according to an embodiment.

FIG. 16 shows an encoding process according to an embodiment.

FIG. 17 shows a decoding process according to an embodiment.

### DESCRIPTION OF EXAMPLE EMBODIMENTS

The following description and drawings are illustrative and are not to be construed as unnecessarily limiting. The specific details are provided for a thorough understanding of the disclosure. However, in certain instances, well-known or conventional details are not described in order to avoid obscuring the description. References to one or an embodiment in the present disclosure can be, but not necessarily are, reference to the same embodiment and such references mean at least one of the embodiments.

Reference in this specification to “one embodiment” or “an embodiment” means that a particular feature, structure, or characteristic described in connection with the embodiment is included in at least one embodiment of the disclosure.

In the following, several embodiments will be described in the context of one video coding arrangement. It is to be noted, however, that the present embodiments are not necessarily limited to this particular arrangement. The embodiments relate to transform selection for intra block copy.

The Advanced Video Coding standard (which may be abbreviated AVC or H.264/AVC) was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organization for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

The High Efficiency Video Coding standard (which may be abbreviated HEVC or H.265/HEVC) was developed by the Joint Collaborative Team-Video Coding (JCT-VC) of VCEG and MPEG. The standard is published by both parent standardization organizations, and it is referred to as ITU-T Recommendation H.265 and ISO/IEC International Standard 23008-2, also known as MPEG-H Part 2 High Efficiency Video Coding (HEVC). Extensions to H.265/HEVC include scalable, multiview, three-dimensional, and fidelity range extensions, which may be referred to as SHVC, MV-HEVC, 3D-HEVC, and REXT, respectively. The references in this description to H.265/HEVC, SHVC, MV-HEVC, 3D-HEVC and REXT that have been made for the purpose of understanding definitions, structures or concepts of these standard specifications are to be understood to be references to the latest versions of these standards that were available before the date of this application, unless otherwise indicated.

Versatile Video Coding (which may be abbreviated VVC, H.266, or H.266/VVC) is a video compression standard developed as the successor to HEVC. VVC is specified in ITU-T Recommendation H.266 and equivalently in ISO/IEC 23090-3, which is also referred to as MPEG-I Part 3. A specification of the AV1 bitstream format and decoding process were developed by the Alliance of Open Media (AOM). The AV1 specification was published in 2018. AOM is reportedly working on the AV2 specification.

Some key definitions, bitstream and coding structures, and concepts of H.264/AVC, HEVC, VVC, and/or AV1 and some of their extensions are described in this section as an example of a video encoder, decoder, encoding method, decoding method, and a bitstream structure, wherein the embodiments may be implemented. The aspects of various embodiments are not limited to H.264/AVC, HEVC, VVC, and/or AV1 or their extensions, but rather the description is given for one possible basis on top of which the present embodiments may be partly or fully realized.

A video codec may comprise an encoder that transforms the input video into a compressed representation suited for storage/transmission and a decoder that can uncompress the compressed video representation back into a viewable form. The compressed representation may be referred to as a bitstream or a video bitstream. A video encoder and/or a video decoder may also be separate from each other, i.e., need not form a codec. The encoder may discard some information in the original video sequence in order to represent the video in a more compact form (that is, at lower bitrate). The notation “(de) coder” means an encoder and/or a decoder.

In some video codecs, such as H.265/HEVC, video pictures are divided into coding units (CU) covering the area of the picture. A CU consists of one or more prediction units (PU) defining the prediction process for the samples within the CU and one or more transform units (TU) defining the prediction error coding process for the samples in the said CU. CU may consist of a square block of samples with a size selectable from a predefined set of possible CU sizes. A CU with the maximum allowed size may be named as LCU (largest coding unit) or CTU (coding tree unit), and the video picture is divided into non-overlapping CTUs. A CTU can be further split into a combination of smaller CUs, e.g., by recursively splitting the CTU and resultant CUs. Each resulting CU may have at least one PU and at least one TU associated with it. Each PU and TU can be further split into smaller PUs and TUs in order to increase granularity of the prediction and prediction error coding processes, respectively. Each PU has prediction information associated with it defining what kind of a prediction is to be applied for the pixels within that PU (e.g., motion vector information for inter predicted PUs and intra prediction directionality information for intra predicted PUs). Similarly, each TU is associated with information describing the prediction error decoding process for the samples within the said TU (including e.g., DCT coefficient information). It may be signaled at CU level whether prediction error coding is applied or not for each CU. In the case there is no prediction error residual associated with the CU, it can be considered there are no TUs for the said CU. The division of the image into CUs, and division of CUs into PUs and TUs may be signaled in the bitstream allowing the decoder to reproduce the intended structure of these units.

Hybrid video codecs, for example ITU-T H.263, H.264/AVC and HEVC, may encode the video information in two phases. At first, pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). In the first phase, predictive coding may be applied, for example, as so-called sample prediction and/or so-called syntax prediction.

In the sample prediction, pixel or sample values in a certain picture area or “block” are predicted. These pixel or sample values can be predicted, for example, using one or more of motion compensation or intra prediction mechanisms.

Motion compensation mechanisms (which may also be referred to as inter prediction, temporal prediction or motion-compensated temporal prediction or motion-compensated prediction or MCP) involve finding and indicating an area in one of the previously encoded video frames that corresponds closely to the block being coded. Inter prediction may reduce temporal redundancy.

Intra prediction, where pixel or sample values can be predicted by spatial mechanisms, involve finding and indicating a spatial region relationship. Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

In the syntax prediction, which may also be referred to as parameter prediction, syntax elements and/or syntax element values and/or variables derived from syntax elements are predicted from syntax elements (de) coded earlier and/or variables derived earlier. Non-limiting examples of syntax prediction are provided below.

In motion vector prediction, motion vectors e.g., for inter and/or inter-view prediction may be coded differentially with respect to a block-specific predicted motion vector. In many video codecs, the predicted motion vectors are created in a predefined way, for example by calculating the median of the encoded or decoded motion vectors of the adjacent blocks. Another way to create motion vector predictions, sometimes referred to as advanced motion vector prediction (AMVP), is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index is typically predicted from adjacent blocks and/or co-located blocks in temporal reference picture. Differential coding of motion vectors is typically disabled across slice boundaries.

The block partitioning, e.g., from CTU to CUs and down to PUs, may be predicted.

In filter parameter prediction, the filtering parameters e.g., for sample adaptive offset may be predicted.

Prediction approaches using image information from a previously coded image can also be called as inter prediction methods which may also be referred to as temporal prediction and motion compensation.

Prediction approaches using image information within the same image can also be called as intra prediction methods.

Secondly, the prediction error, i.e., the difference between the predicted block of pixels and the original block of pixels, is coded. This may be done by transforming the difference in pixel values using a specified transform (e.g., Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size of transmission bitrate).

An elementary unit for the input to an encoder and the output of a decoder, respectively, in most cases is a picture. A picture given as an input to an encoder may also be referred to as a source picture, and a picture decoded by a decoded may be referred to as a decoded picture or a reconstructed picture.

The source and decoded pictures are each comprised of one or more sample arrays, such as one of the following sets of sample arrays:
Luma (Y) only (monochrome).
Luma and two chroma (YCbCr or YCgCo).
Green, Blue and Red (GBR, also known as RGB).
Arrays representing other unspecified monochrome or tri-stimulus color samplings (for example, YZX, also known as XYZ).

In the following, these arrays may be referred to as luma (or L or Y) and chroma, where the two chroma arrays may be referred to as Cb and Cr; regardless of the actual color representation method in use. The actual color representation method in use can be indicated e.g., in a coded bitstream e.g., using the Video Usability Information (VUI) syntax of HEVC or alike. A component may be defined as an array or single sample from one of the three sample arrays (luma and two chroma) or the array or a single sample of the array that compose a picture in monochrome format.

A picture may be defined to be either a frame or a field. A frame comprises a matrix of luma samples and possibly the corresponding chroma samples. A field is a set of alternate sample rows of a frame and may be used as encoder input, when the source signal is interlaced. Chroma sample arrays may be absent (and hence monochrome sampling may be in use) or chroma sample arrays may be subsampled when compared to luma sample arrays.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

The motion information may be indicated with motion vectors associated with each motion compensated image block in video codecs. Each of these motion vectors represents the displacement of the image block in the picture to be coded (in the encoder side) or decoded (in the decoder side) and the prediction source block in one of the previously coded or decoded pictures. In order to represent motion vectors efficiently those may be coded differentially with respect to block specific predicted motion vectors. The predicted motion vectors may be created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index may be predicted from adjacent blocks and/or or co-located blocks in temporal reference picture. Moreover, high efficiency video codecs may employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signaled among a list of motion field candidate list filled with motion field information of available adjacent/co-located blocks.

H.264/AVC and HEVC, as many other video compression standards, a picture is divided into a mesh of rectangles, for each of which a similar block in one of the reference pictures is indicated for inter prediction. The location of the prediction block is coded as a motion vector that indicates the position of the prediction block relative to the block being coded.

A bitstream may be defined as a sequence of bits or a sequence of syntax structures. A bitstream format may constrain the order of syntax structures in the bitstream.

A syntax element may be defined as an element of data represented in the bitstream. A syntax structure may be defined as zero or more syntax elements present together in the bitstream in a specified order.

In some coding formats or standards, a bitstream may be in the form of a network abstraction layer (NAL) unit stream or a byte stream, which forms the representation of coded pictures and associated data forming one or more coded video sequences.

A NAL unit may be defined as a syntax structure containing an indication of the type of data to follow and bytes containing that data in the form of an RBSP interspersed as necessary with start code emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

A NAL unit comprises a header and a payload. The NAL unit header indicates the type of the NAL unit among other things.

In some coding formats, such as AV1, a bitstream may comprise a sequence of open bitstream units (OBUs). An OBU comprises a header and a payload, wherein the header identifies a type of the OBU. Furthermore, the header may comprise a size of the payload in bytes.

The phrase along the bitstream (e.g., indicating along the bitstream) or along a coded unit of a bitstream (e.g., indicating along a coded tile) may be used in claims and described embodiments to refer to transmission, signaling, or storage in a manner that the “out-of-band” data is associated with but not included within the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively. For example, the phrase along the bitstream may be used when the bitstream is contained in a container file, such as a file conforming to the ISO Base Media File Format, and certain file metadata is stored in the file in a manner that associates the metadata to the bitstream, such as boxes in the sample entry for a track containing the bitstream, a sample group for the track containing the bitstream, or a timed metadata track associated with the track containing the bitstream.

Video codecs may support motion compensated prediction from one source image (uni-prediction) and two sources (bi-prediction). In the case of uni-prediction a single motion vector is applied whereas in the case of bi-prediction two motion vectors are signaled and the motion compensated predictions from two sources are averaged to create the final sample prediction. In the case of weighted prediction, the relative weights of the two predictions can be adjusted, or a signaled offset can be added to the prediction signal.

In addition to applying motion compensation for inter picture prediction, similar approach can be applied to intra picture prediction. In this case the displacement vector indicates where from the same picture a block of samples can be copied to form a prediction of the block to be coded or decoded. This kind of intra block copying methods can improve the coding efficiency substantially in presence of repeating structures within the frame-such as text or other graphics.

The prediction residual after motion compensation or intra prediction may be first transformed with a transform kernel (like DCT) and then coded. The reason for this is that often there still exists some correlation among the residual and transform can in many cases help reduce this correlation and provide more efficient coding.

Video encoders may utilize Lagrangian cost functions to find optimal coding modes, e.g., the desired Macroblock mode and associated motion vectors. This kind of cost function uses a weighting factor λ to tie together the (exact or estimated) image distortion due to lossy coding methods and the (exact or estimated) amount of information that is required to represent the pixel values in an image area:

$$C = D + λ R \qquad ( Eq . 1 )$$

Where C is the Lagrangian cost to be minimized, D is the image distortion (e.g., Mean Squared Error) with the mode and motion vectors considered, and R the number of bits needed to represent the required data to reconstruct the image block in the decoder (including the amount of data to represent the candidate motion vectors).

Features and coding tools included in VVC include the following:
Intra prediction
   67 intra mode with wide angles mode extension
   Block size and mode dependent 4 tap interpolation filter
   Position dependent intra prediction combination (PDPC)
   Cross component linear model intra prediction (CCLM)
   Multi-reference line intra prediction
   Intra sub-partitions
   Weighted intra prediction with matrix multiplication
Inter-picture prediction
   Block motion copy with spatial, temporal, history-based, and pairwise average merging candidates
   Affine motion inter prediction
   sub-block based temporal motion vector prediction
   Adaptive motion vector resolution
   8×8 block-based motion compression for temporal motion prediction
   High precision ( 1/16 pel) motion vector storage and motion compensation with 8-tap interpolation filter for luma component and 4-tap interpolation filter for chroma component
   Triangular partitions
   Combined intra and inter prediction
   Merge with MVD (MMVD)
   Symmetrical MVD coding
   Bi-directional optical flow Decoder side motion vector refinement
   Bi-prediction with CU-level weight
Transform, quantization and coefficients coding
   Multiple primary transform selection with DCT2, DST7 and DCT8
   Secondary transform for low frequency zone
   Sub-block transform for inter predicted residual
   Dependent quantization with max QP increased from 51 to 63
   Transform coefficient coding with sign data hiding
   Transform skip residual coding
Entropy Coding
   Arithmetic coding engine with adaptive double windows probability update
In loop filter
   In-loop reshaping
   Deblocking filter with strong longer filter
   Sample adaptive offset
   Adaptive Loop Filter
Screen content coding:
   Current picture referencing with reference region restriction
360-degree video coding
   Horizontal wrap-around motion compensation
High-level syntax and parallel processing
   Reference picture management with direct reference picture list signalling
   Tile groups with rectangular shape tile groups

In H.266/VVC, the following block partitioning applies. Pictures may be divided into coding tree units (CTUs). A picture may also be divided into slices, tiles, bricks, and sub-pictures. CTU may be split into smaller CUs using quaternary tree structure. Each CU may be divided using quad-tree and nested multi-type tree including ternary and binary split.

There are specific rules to infer partitioning in in picture boundaries.

The redundant split patterns are disallowed in nested multi-type partitioning.

Some video coding tools perform filtering operations which convolve a set of reference samples with a set of filter parameters to output, for example, a predicted value for a certain sample in a picture. In some cases, the filter parameters may be predetermined or signaled in the bitstream. In other cases, such as when cross-component linear model (CCLM) or cross-component convolutional model (CCCM) prediction is used, the parameters are calculated using a set of reference samples in both encoder and decoder. Generally, calculation of such filter parameter involves inversion of an auto-correlation matrix, which is a computationally challenging operation. Also, when there are many filter parameters to be determined, the size of the auto-correlation matrix becomes large, which can cause numerical stability issues (overflows or underflows).

To reduce the cross-component redundancy, a cross-component linear model (CCLM) prediction mode may be used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 3 - 1 )$$

where pred_{C}(i, j) represents the predicted chroma samples in a CU, and rec_{L}′(i, j) represents the downsampled reconstructed luma samples of the same CU.

The CCLM parameters (a and B) are derived with at most four neighbouring chroma samples and their corresponding down-sampled luma samples. Suppose the current chroma block dimensions are W×H, then W′ and H′ are set as
W′=W, H′=H when LM mode is applied;
W′=W+H when LM-A mode is applied;
H′=H+W when LM-L mode is applied.

The above neighboring positions are denoted as S[0, −1] . . . S[W′−1, −1] and the left neighbouring positions are denoted as S[−1, 0] . . . S[−1, H′−1]. Then the four samples are selected as
S[W′/4, −1], S[3*W′/4, −1], S[−1, H′/4], S[−1, 3*H′/4] when LM mode is applied and both above and left neighbouring samples are available;
S[W′/8, −1], S[3*W′/8, −1], S[5*W′/8, −1], S[7*W′/8, −1] when LM-A mode is applied or only the above neighboring samples are available;
S[−1, H′/8], S[−1, 3*H′/8], S[−1, 5*H′/8], S[−1, 7*H′/8] when LM-L mode is applied or only the left neighboring samples are available.

The four neighboring luma samples at the selected positions are down-sampled and compared four times to find two smaller values: x0A and x1A, and two larger values: x0B and x1B. Their corresponding chroma sample values are denoted as y0A, y1A, y0B and y1B. Then xA, xB, yA and yB are derived as

$${X}_{a} = ( {x}_{A}^{0} + {x}_{A}^{1} + 1 ) ≫ 1 ;$$

$${X}_{b} = ( {x}_{B}^{0} + {x}_{B}^{1} + 1 ) ≫ 1 ;$$

$${Y}_{a} = ( {y}_{A}^{0} + {y}_{A}^{1} + 1 ) ≫ 1 ;$$

$${Y}_{b} = ( {y}_{B}^{0} + {y}_{B}^{1} + 1 ) ≫ 1$$

Finally, the linear model parameters are obtained according to the following equations:

$$α = \frac{{Y}_{a} - {Y}_{b}}{{X}_{a} - {X}_{b}}$$

$$β = {Y}_{b} - α \cdot {X}_{b}$$

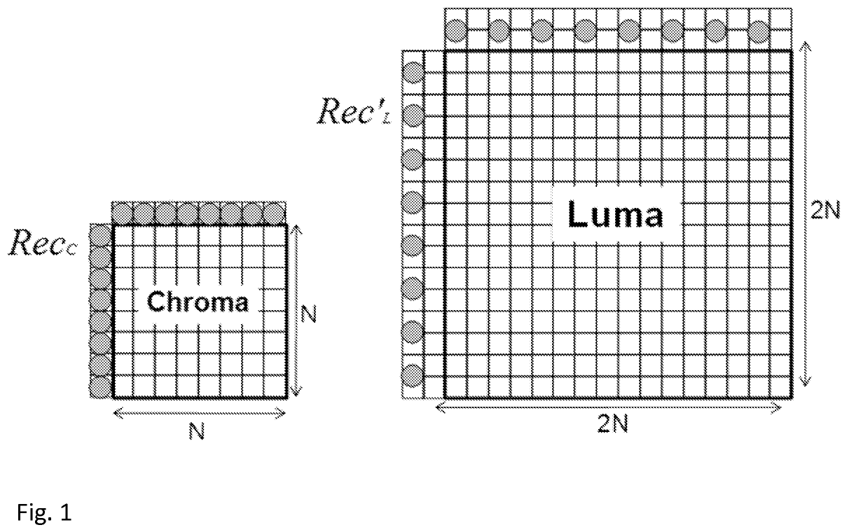

FIG. 1 shows an example of the location of the left and above samples and the sample of the current block involved in the CCLM mode. The division operation to calculate parameter a is implemented with a look-up table. To reduce the memory required for storing the table, the diff value (difference between maximum and minimum values) and the parameter a are expressed by an exponential notation. For example, diff is approximated with a 4-bit significant part and an exponent. Consequently, the table for 1/diff is reduced into 16 elements for 16 values of the significant as follows:

$$DivTable [ ] = \{ 0 , 7 , 6 , 5 , 5 , 4 , 4 , 3 , 3 , 2 , 2 , 1 , 1 , 1 , 1 , 0 \}$$

This would have a benefit of both reducing the complexity of the calculation as well as the memory size required for storing the needed tables.

Besides the above template and left template can be used to calculate the linear model coefficients together, they can also be used alternatively in the other 2 LM modes, called LM_A, and LM_L modes.

In LM_A mode, only the above template is used to calculate the linear model coefficients. To get more samples, the above template is extended to (W+H). In LM_L mode, only left template is used to calculate the linear model coefficients. To get more samples, the left template is extended to (H+W).

For a non-square block, the above template is extended to W+W, the left template is extended to H+H.

To match the chroma sample locations for 4:2:0 video sequences, two types of downsampling filter are applied to luma samples to achieve 2 to 1 downsampling ratio in both horizontal and vertical directions. The selection of downsampling filter is specified by a SPS level flag. The two downsampling filters are as follows, which are corresponding to “type-0” and “type-2” content, respectively.

$${Rec}_{L}^{′} ( i , j ) = [ \begin{matrix}{rec}_{L} ( 2 i - 1 , 2 j - 1 ) + 2 \cdot {rec}_{L} ( 2 i - 1 , 2 j - 1 ) + {rec}_{L} ( 2 i + 1 , 2 j - 1 ) + \\ {rec}_{L} ( 2 i - 1 , 2 j ) + 2 \cdot {rec}_{L} ( 2 i , 2 j ) + {rec}_{L} ( 2 i + 1 , 2 j ) + 4\end{matrix} ] ≫ 3$$

$${rec}_{L}^{′} ( i , j ) = [ \begin{matrix}{rec}_{L} ( 2 i , 2 j - 1 ) + {rec}_{L} ( 2 i - 1 , 2 j ) + 4 \cdot {rec}_{L} ( 2 i , 2 j ) + \\ {rec}_{L} ( 2 i + 1 , 2 j ) + {rec}_{L} ( 2 i , 2 j + 1 ) + 4\end{matrix} ] ≫ 3$$

It is appreciated that only one luma line (general line buffer in intra prediction) is used to make the down-sampled luma samples when the upper reference line is at the CTU boundary.

This parameter computation is performed as part of the decoding process and is not just as an encoder search operation. As a result, no syntax is used to convey the α and β values to the decoder.

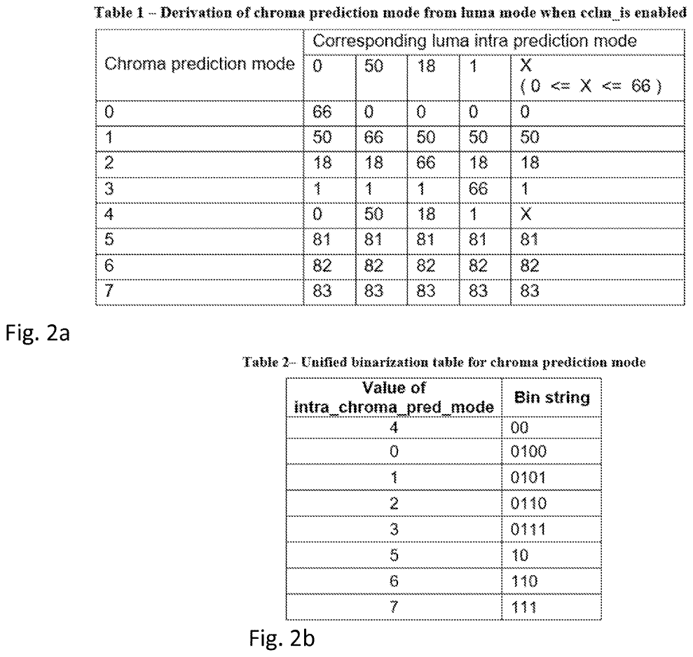

For chroma intra mode coding, a total of 8 intra modes are allowed for chroma intra mode coding. Those modes include five traditional intra modes and three cross-component linear model modes (CCLM, LM_A, and LM_L). Chroma mode signalling and derivation process are shown in Table 1 in FIG. 2a. Chroma mode coding directly depends on the intra prediction of the corresponding luma block. Since separate block partitioning structure for luma and chroma components is enable in I slices, one chroma block may correspond to multiple luma blocks. Therefore, for Chroma DM mode, the intra prediction mode of the corresponding luma block covering the center position of the current chroma block is directly inherited.

A single binarization table is used regardless of the values of sps_cclm_enabled_flag as shown in Table 2 in FIG. 2b. In Table 2, the first bin indicates whether it is regular (0) or LM modes (1). If it is LM mode, then the next bin indicates whether it is LM_CHROMA (0) or not. If it is not LM_CHROMA, next 1 bin indicates whether it is LM_L (0) or LM_A (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bines in Table 3-4 are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node are allowed to use CCLM in the following way:
If the 32×32 chroma node is not split or partitioned QT split, all chroma CUs in the 32×32 node can use CCLM
If the 32×32 chroma node is partitioned with Horizontal BT, and the 32×17 child node does not split or use Vertical BT split, all chroma CUs in the 32×16 chroma node can use CCLM.
   In all the other luma and chroma coding tree split conditions, CCLM is not allowed for chroma CU.

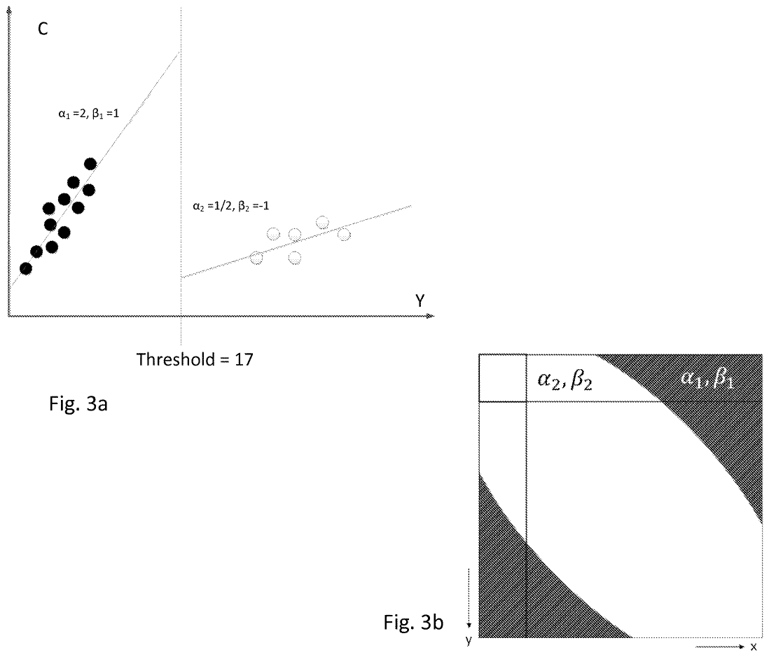

The CCLM included in VVC is extended by adding three Multi-model LM (MMLM) modes. In each MMLM mode, the reconstructed neighbouring samples are classified into two classes using a threshold which is the average of the luma reconstructed neighboring samples. The linear model of each class is derived using the Least-Mean-Square (LMS) method. For the CCLM mode, the LMS method is also used to derive the linear model. FIG. 3a illustrates two luma-to-chroma models obtained for luma (Y) threshold of 17. Each luma-to-chroma model has its own linear model parameters α and β. As can be seen from FIG. 3b, each luma-to-chroma model corresponds to a spatial segmentation of the content (i.e., they correspond to different objects or textures in the scene).

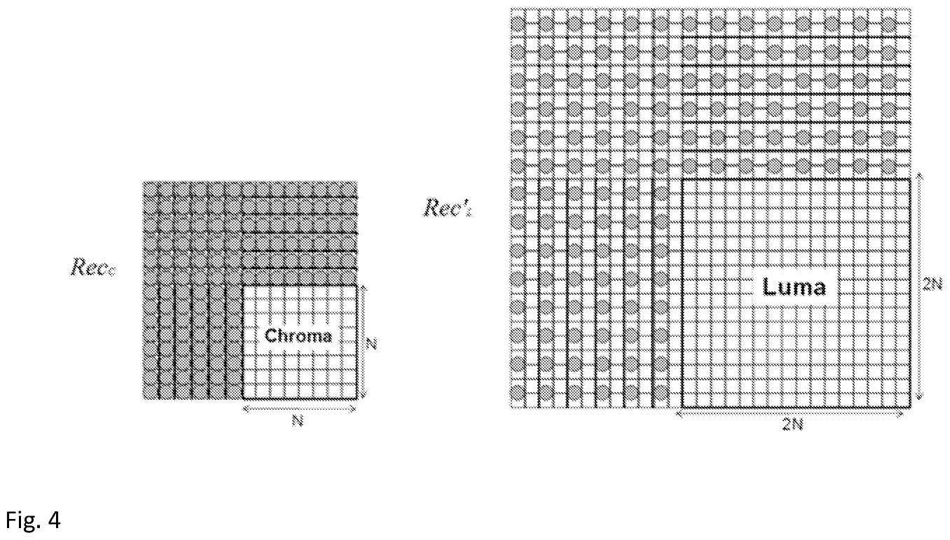

An improved version of cross-component prediction, known as convolutional cross-component model (CCCM), uses 2D filter kernel to derive the luma-to-chroma model. The filter coefficients are derived decoder-side using reconstructed set of input data and chroma samples. For the filter coefficient derivation, co-located reference sample areas (consisting of reconstructed luma and chroma samples) are defined for both luma and chroma as shown in FIG. 4, yet any number of reference lines (that can be realized by both the encoder and decoder) can be used. Generally, reference samples can contain any chroma and luma samples that have been reconstructed by both the encoder and decoder. Once the reference samples have been determined, the filter coefficients can be derived, for example, using different types of linear regression tools such as ordinary least-squares estimation, orthogonal matching pursuit, optimized orthogonal matching pursuit, ridge regression, or least absolute shrinkage and selection operator.

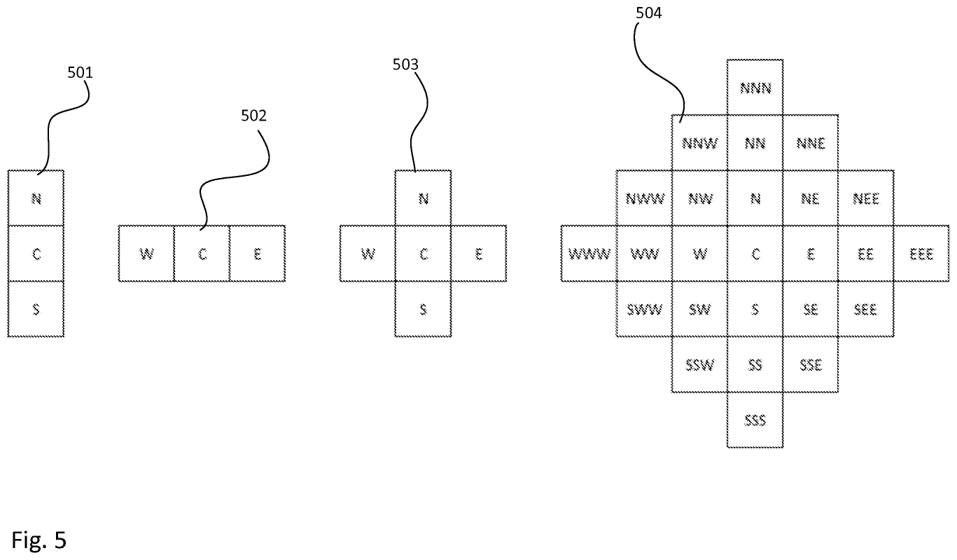

The dimensions of the filter kernel can be for example 1×3 (1D vertical), 3×1 (1D horizontal), 3×3, 7×7 or any dimensions, and can be shaped (by selecting only a subset of all possible kernel locations) as a cross or a diamond or as any given shape. When referring to the samples within the filter kernel, the following notation is used: north (above), east (right), south (below), west (left) and center, as illustrated in FIG. 5 using the letters N, E, S, W, C. FIG. 5 illustrate a 3-tap vertical kernel 501, 3-tap horizontal kernel 502, 5-tap cross kernel 503 and 25-tap diamond kernel 504.

The overall method of reconstructing chroma samples using convolution between a decoder-side obtained filter kernel and a set of input data is referred to as convolutional cross-component model (CCCM) here. The following steps can be applied to perform a CCCM operation:
Define co-located reference areas over the luma and chroma components;
Down-sample the luma samples to match the chroma grid (optional);
Scan the luma and chroma samples of the reference area and collet available statistics (such as auto-correlation matrix and cross-correlation vector) based on the filter shape;
Solve the filter coefficients by minimizing squared-error (or any other metric) based on the available statistics (such as the auto-correlation matrix and cross-correlation vector);
Calculate a predicted chroma block by convolving the down-sampled luma samples with the filter kernel.

In the following, the (possibly down-sampled) luma samples are defined as a 2D array Y(x, y) indexed using horizontal x-coordinate and vertical y-coordinate. Also, the co-located chroma samples are defined as a 2D array C(x, y) and the filter kernel (i.e., coefficients) as 3×3 array F(i, j). On a sample level, the convolution between Y and F is defined as

$$( x , y ) = {\sum }_{j = - 1}^{j = 1} {\sum }_{i = - 1}^{i = 1} Y ( x + i , y + j ) \cdot F ( i + 1 , j + 1 ) .$$

When using other data terms, such as the non-linear square-root term, the appended convolution becomes

$$C ( x , y ) = ( {\sum }_{j = - 1}^{j = 1} {\sum }_{i = - 1}^{i = 1} Y ( x + i , y + j ) \cdot F ( i + 1 , j + 1 ) ) + \hat{F} ( 0 ) \cdot \sqrt{Y ( x , y )} ,$$

where \hat{F} are filter coefficients that reside outside of the 2D filter kernel yet have been obtained as a part of the system of linear equations that were used to solve the 2D filter coefficients in Step 4 above. Similarly, the bias term can be added to the convolution with

$$C ( x , y ) = ( {\sum }_{j = - 1}^{j = 1} {\sum }_{i = - 1}^{i = 1} Y ( x + i , y + j ) \cdot F ( i + 1 , j + 1 ) ) + \hat{F} ( 0 ) + \hat{F} ( 1 ) \cdot \sqrt{Y ( x , y )} .$$

Angular intra prediction (a.k.a. directional intra prediction) may be performed by extrapolating sample values from the reconstructed reference samples utilizing a given directionality. The reference samples may comprise the immediately neighboring sample row above and above-right of the current block (when available) and the immediately neighboring sample column on the left of the current block (when available), wherein availability may require decoding order earlier than that of the current block and presence in the same image segment, such as in the same tile. In order to simplify the process, all sample locations within one prediction block may be projected to a single reference row or column depending on the directionality of the selected prediction mode. A predicted sample within the block being encoded/decoded may be obtained by the following steps:
Projecting the location of a predicted sample to a location within a reference row or column by applying the selected prediction direction. The location within the reference row or column may have fractional sample accuracy, such as 1/32 pixel accuracy.
Interpolating a value for the sample location on the reference row or column from the reference samples at the reference row/column.

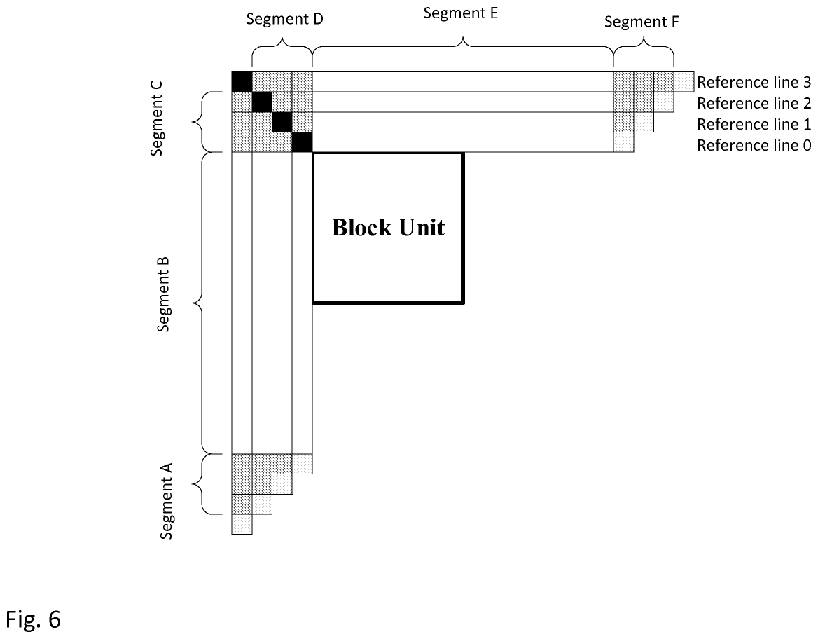

Multiple reference line (MRL) intra prediction uses more reference lines for intra prediction. In FIG. 6, an example of four reference lines is depicted, where the samples of segments A and F are not fetched from reconstructed neighboring samples but padded with the closest samples from Segment B and E, respectively. HEVC intra-picture prediction uses the nearest reference line (i.e., reference line 0). In MRL, two additional lines (reference line 1 and reference line 3) are used.

The index of selected reference line (mrl_idx) is signaled and used to generate intra predictor. For reference line idx, which is greater than 0, only include additional reference line modes in MPM list and only signal mpm index without remaining mode. The reference line index is signaled before intra prediction modes, and Planar mode is excluded from intra prediction modes in case a nonzero reference line index is signaled.

MRL is disabled for the first line of blocks inside a CTU to prevent using extended reference samples outside the current CTU line. Also, PDPC is disabled when additional line is used. For MRL mode, the derivation of DC value in DC intra prediction mode for non-zero reference line indices are aligned with that of reference line index 0. MRL requires the storage of 3 neighbouring luma reference lines with a CTU to generate predictions. The Cross-Component Linear Model (CCLM) tool also requires 3 neighboring luma reference lines for its own down-sampling filters. The definition of MLR to use the same 3 lines is aligned as CCLM to reduce the storage requirements for decoders.

The intra sub-partitions (ISP) divides luma intra-predicted blocks vertically or horizontally into 2 or 4 sub-partitions depending on the block size. For example, minimum block size for ISP is 4×8 (or 8×4). If block size is greater than 4×8 (or 8×4), then the corresponding block is divided by four sub-partitions. It has been noticed that the M×12 (with M≤64) and 128×N (with N≤ 64) ISP blocks could generate a potential issue with the 64×64 VDPU. For example, and M×128 CU in the single tree case has an M×128 luma TB and two corresponding

$$\frac{M}{2} \times 64$$

chroma TBs. If the CU uses ISP, then the luma TB will be divided into four M×32 TBs (only the horizontal split is possible), each of them smaller than a 64×64 block. However, in the current design of ISP, chroma blocks are not divided. Therefore, both chroma components will have a size greater than a 32×32 block.

Analogously, a similar situation could be created with a 128×N CU using ISP. Hence, these two cases are an issue for the 64×64 decoder pipeline. For this reason, the CU sizes that can use ISP is restricted to a maximum 64×64. All sub-partitions fulfil the condition of having at least 16 samples.

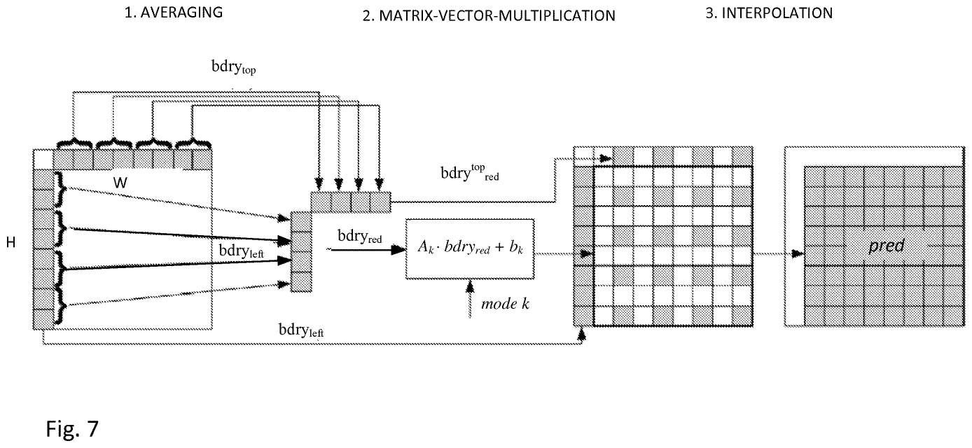

Matrix weighted intra prediction (MIP) method is an intra prediction technique in VVC. For predicting the samples of a rectangular block of width W and height H, matrix weighted intra prediction (MIP) takes one line of H reconstructed neighbouring boundary samples left of the block and one line of W reconstructed neighboring boundary samples above the block as input. If the reconstructed samples are unavailable, they are generated as it is done in the conventional intra prediction. The generation of the prediction signal is based on the following three steps, which are averaging, matrix vector multiplication and linear interpolation as shown in FIG. 7.

When Decoder side Intra Mode Derivation (DIMD) is applied, two intra modes are derived from the reconstructed neighbor samples, and those predictors are combined with the planar mode predictor with the weights derived from the gradients. The division operations in weight derivation are performed utilizing the same lookup table (LUT) based integerization scheme used by the CCLM. For example, the division operation in the orientation calculation

$$Orient = {G}_{y} / {G}_{x}$$

is computed by the following LUT-based scheme:

$$x = Floor ( Log 2 ( Gx ) )$$

$$normDiff = ( ( Gx ≪ 4 ) ≫ x ) \& 15$$

$$x += ( 3 + ( normDiff != 0 ) ? 1 : 0 )$$

$$Orient = ( Gy * ( DivSigTable [ normDiff ] \vert 8 ) + ( 1 ≪ ( x - 1 ) ) ) ≫ x where$$

$$DivSigTable [ 16 ] = \{ 0 , 7 , 6 , 5 , 5 , 4 , 4 , 3 , 3 , 2 , 2 , 1 , 1 , 1 , 1 , 0 \} .$$

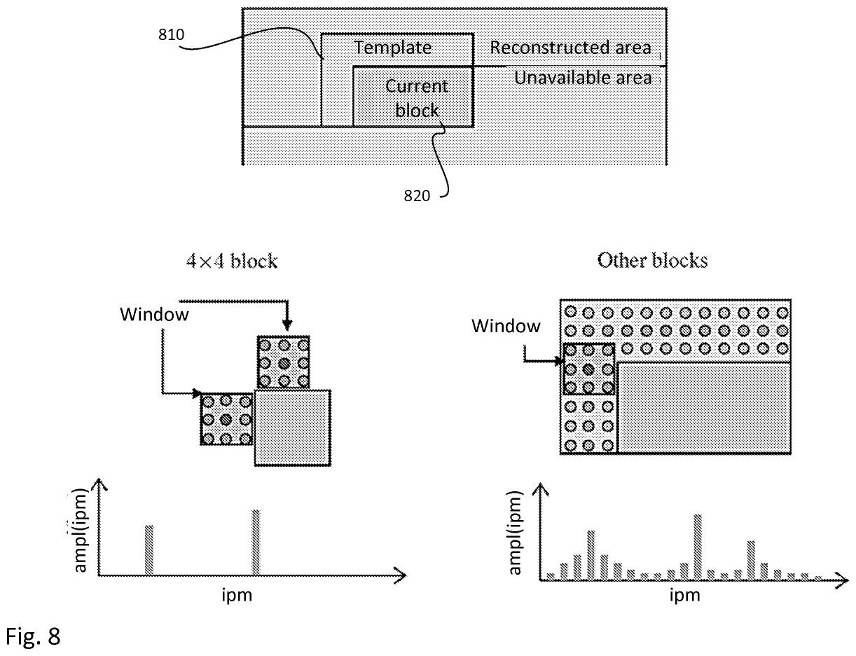

Derived intra modes are included into the primary list of intra most probable modes (MPM), and therefore the DIMD process is performed before the MPM list is constructed. The primary derived intra mode of a DIMD block is stored with a block and is used for MPM list construction of the neighboring blocks. FIG. 8 illustrates an example of a template 810 for a current block 820, and an example of HoG (Histogram of Oriented Gradients) calculation from a template of width 3 pixels.

For each intra prediction mode in MPMs, the sum of absolute transformed differences (SATD) between the prediction and reconstruction samples of the template are calculated. First two intra prediction modes with the minimum SATD are selected as the Template-based Intra Mode Derivation (TIMD) modes. These two TIMD modes are fused with the weights after applying PDPC process, and such weighted intra prediction is used to code the current CU. Position dependent intra prediction combination (PDPC) is included in the derivation of the TIMD modes. The costs of the two selected modes are compared with a threshold, in the test of the cost factor of 2 is applied as follows:

$$costMode2 < 2 * costMode1$$

If this condition is true, the fusion is applied, otherwise the only mode1 is used.

Weights of the modes are computed from their SATD costs as follows:

$$weight1 = costMode2 / ( costMode1 + costMode2 )$$

$$weight2 = 1 - weight1$$

The division operations are conducted using the same lookup table (LUT) based integerization scheme used by the CCLM.

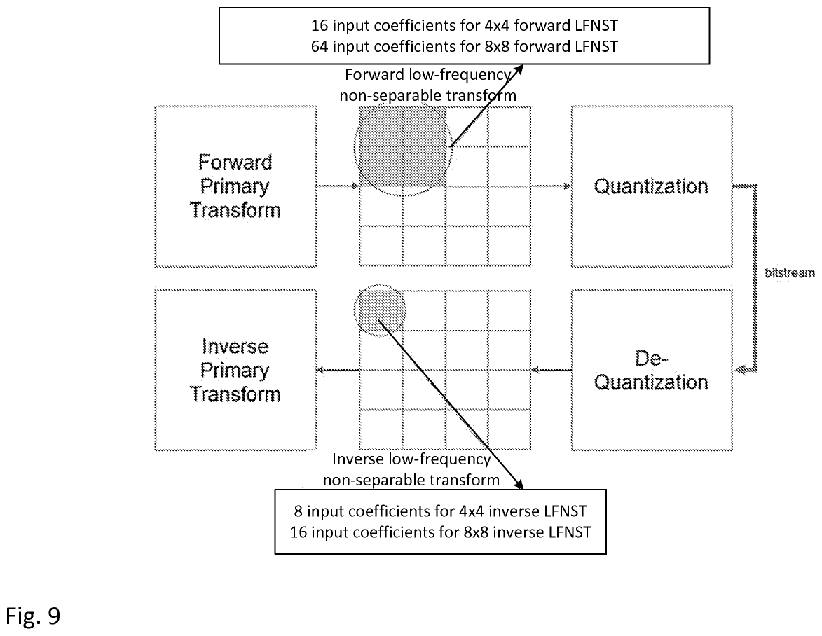

In VVC, Low-frequency non-separable transform (LFNST) may be applied between forward primary transform and quantization (at encoder) and between de-quantization and inverse primary transform (at decoder side) as shown in FIG. 9. In LFNST, 4×4 non-separable transform or 8×8 non-separable transform is applied according to block size. For example, 4×4 LFNST is applied for small blocks (i.e., min (width, height)<8) and 8×8 LFNST is applied for larger blocks (i.e., min (width, height)>4).

Application of a non-separable transform, which is being used in LFNST, is described as follows using input as an example. To apply 4×4 LFNST, the 4×4 input block X

$$X = [ \begin{matrix}{X}_{00} & {X}_{01} & {X}_{02} & {X}_{03} \\ {X}_{10} & {X}_{11} & {X}_{12} & {X}_{13} \\ {X}_{20} & {X}_{21} & {X}_{22} & {X}_{23} \\ {X}_{30} & {X}_{31} & {X}_{32} & {X}_{33}\end{matrix} ]$$

is first represented as a vector X:

$$\vec{X} = {[ \begin{matrix}{X}_{00} & {X}_{01} & {X}_{02} & {X}_{03} & {X}_{10} & {X}_{11} & {X}_{12} & {X}_{13} & {X}_{20} & {X}_{21} & {X}_{22} & {X}_{23} & {X}_{30} & {X}_{31} & {X}_{32} & {X}_{33}\end{matrix} ]}^{T}$$

The non-separable transform is calculated as [symbol] =T· [symbol] where F indicates the transform coefficient vector, and T is a 16×16 transform matrix. The 16×1 coefficient vector [symbol] is subsequently reorganized as 4×4 block using the scanning order for that block (horizontal, vertical, or diagonal). The coefficients with smaller index will be placed with the smaller scanning index in the 4×4 coefficient block.

LFNST is based on direct matrix multiplication approach to apply non-separable transform whereby it is implemented in a single pass without multiple iterations. However, the non-separable transform matrix dimensions need to be reduced to minimize computational complexity and memory space to store the transform coefficients. Hence, reduced non-separable transform (or RST) method is used in LFNST. The main idea of the reduced non-separable transform is to map an N (N is commonly equal to 64 for 8×8 NSST) dimensional vector to an R dimensional vector in a different space, where N/R (R<N) is the reduction factor. Hence, instead of N×N matrix, RST matrix becomes and R×N matrix as follows:

$${T}_{R \times N} = [ \begin{matrix}{t}_{11} & {t}_{12} & {t}_{13} & … & {t}_{1 N} \\ {t}_{21} & {t}_{22} & {t}_{23} & & {t}_{2 N} \\ & ⋮ & & ⋱ & ⋮ \\ {t}_{R 1} & {t}_{R 2} & {t}_{R 3} & … & {t}_{RN}\end{matrix} ]$$

where the R rows of the transform are R bases of the N dimensional space. The inverse transform matrix for RT is the transpose of its forward transform. For 8×8 LFNST, a reduction factor of 4 is applied, and 64×64 direct matrix, which is conventional 8×8 non-separable transform matrix size, is reduced to 16×48 direct matrix. Hence, the 48×16 inverse RST matrix is used at the decoder side to generate core (primary) transform coefficients in 8×8 top-left regions. When 16×48 matrices are applied instead of 16×64 with the same transform set configuration, each of which takes 48 input data from three 4×4 blocks in a top-left 8×8 block excluding right-bottom 4×4 block. With the help of the reduced dimension, memory usage for storing all LFNST matrices is reduced from 10 KB to 8 KB with reasonable performance drop. In order to reduce complexity, LFNST is restricted to be applicable only if all coefficients outside the first coefficient sub-group are non-significant. Hence, all primary-only transform coefficients have to be zero when LFNST is applied. This allows a conditioning of the LFNST index signalling on the last-significant position, and hence avoids the extra coefficient scanning in the current LFNST design, which is needed for checking for significant coefficients at specific positions only. The worst-case handling of LFNST (in terms of multiplications per pixel) restricts the non-separable transforms for 4×4 and 8×8 blocks to 8×16 and 8×48 transforms, respectively. In those cases, the last-significant scan position has to be less than 8, when LFNST is applied, for other sizes less than 16. For blocks with a shape of 4×N and N×4 and N>8, the proposed restriction implies that the LFNST is now applied only once, and that to the top-left 4×4 region only. As all primary-only coefficients are zero when LFNST is applied, the number of operations needed for the primary transforms is reduced in such cases. From encoder perspective, the quantization of coefficients is remarkably simplified when LFNST transforms are tested. A rate-distortion optimized quantization has to be done at maximum for the first 16 coefficients (in scan order), the remaining coefficients are enforced to be zero.

There may be totally four transform sets and two non-separable transform matrices (kernels) per transform set are used in LFNST. The mapping from the intra prediction mode to the transform set is predefined as shown in Table below. If one of the three CCLM modes (INTRA_LT_CCLM, INTRA_T_CCLM or INTRA_L_CCLM) is used for the current block (81<=IntraPredMode<=83), transform set 0 is selected for the current chroma block. For each transform set, the selected non-separable secondary transform candidate is further specified by the explicitly signaled LFNST index. The index is signaled in a bit-stream once per Intra CU after transform coefficients.

| IntraPredMode | Tr. set index |
|---|---|
| IntraPredMode < 0 | 1 |
| 0 <= IntraPredMode <= 1 | 0 |
| 2 <= IntraPredMode <= 12 | 1 |
| 13 <= IntraPredMode <= 23 | 2 |
| 24 <= IntraPredMode <= 44 | 3 |
| 45 <= IntraPredMode <= 55 | 2 |
| 56 <= IntraPredMode <= 80 | 1 |
| 81 <= IntraPredMode <= 83 | 0 |

Since LFNST is restricted to be applicable only if all coefficients outside the first coefficient subgroup are non-significant, LFNST index coding depends on the position of the last significant coefficient. In addition, the LFNST index is context coded but does not depend on intra predication mode, and only the first bit is context coded. Furthermore, LFNST is applied for intra CU in both intra and inter slices, and for both Luma and Chroma. If a dual tree is enabled, LFNST indices for Luma and Chroma are signaled separately. For inter slice (the dual tree is disabled), a single LFNST index is signaled and used for both Luma and Chroma.

Considering that a large CU greater than 64×64 is implicitly split (TU tiling) due to the existing maximum transform size restriction (64×64), and LFNST index search could increase data buffering by four times for a certain number of decode pipeline stages. Therefore, the maximum size that LFNST is allowed, is restricted to 64×64. It is to be noticed that LFNST is enabled with DCT2 only. The LFNST index signaling is placed before Multiple transform selection (MTS) index signaling.

The use of scaling matrices for perceptual quantization is not evident that the scaling matrices that are specified for the primary matrices may be useful for LFNST coefficients. Hence, the uses of the scaling matrices for LFNST coefficients are not allowed. For single-tree partition mode, chroma LFNST is not applied.

In the following, relevant Intra Block Copy and Template-Matching based Intra Block Copy methods will discussed.

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block having such template as a prediction block. The encoder then signals the usage of this mode, and the same prediction operation is performed at the decoder side.

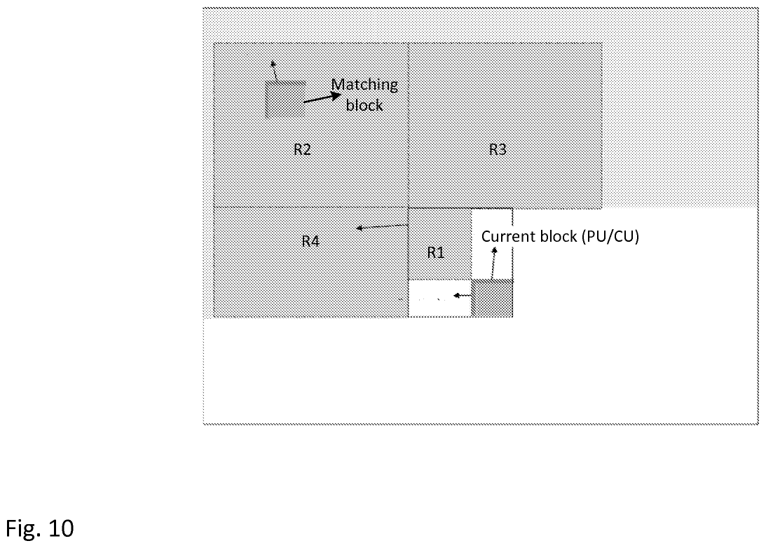

The prediction signal is generated by matching the L-shaped causal neighbor of the current block with another block in a predefined search area in FIG. 10 consisting of:
R1: current CTU
R2: top-left CTU
R3: above CTU
R4: left CTU

Sum of absolute differences (SAD) is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$SearchRange\_w = a * BlkW$$

$$SearchRange\_h = a * BlkH$$

where ‘a’ is a constant that controls the gain/complexity trade-off. In practice, ‘a’ may be equal to 5. It is appreciated that any value can be used instead.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

Template Matching (TM) is used in Intra Block Copy (IBC) for both IBC merge mode and IBC AMVP mode.

The IBC-TM merge list is modified compared to the one used by regular IBC merge mode such that the candidates are selected according to a pruning method with a motion distance between the candidates as in the regular TM merge mode. The ending zero motion fulfillment is replaced by motion vectors to the left (−W, 0), top (0, −H) and top-left (−W, −H), where W is the width and H the height of the current CU.

In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to three candidates are selected from the IBC-TM merge list. Each of those three selected candidates may be refined using the Template Matching method and sorted according to their resulting Template Matching cost. Only the two first ones may then be considered in the motion estimation process as usual.

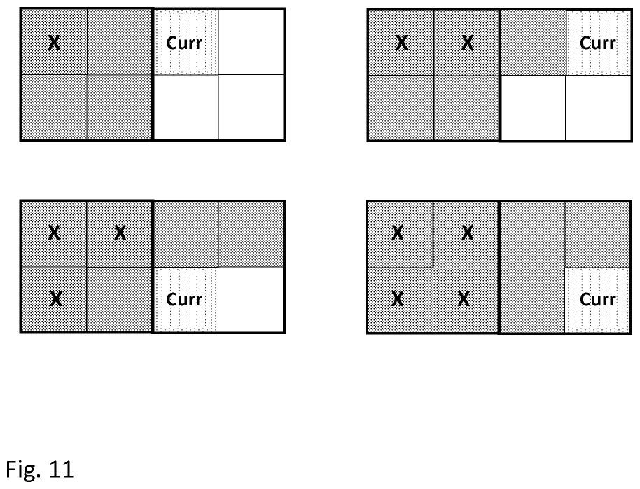

The Template Matching refinement for both IBC-TM merge and AMVP modes is quite simple since IBC motion vectors are constrained (i) to be integer and (ii) within a reference region as shown in FIG. 11. Therefore, in IBC-TM merge mode, all refinements are performed at integer precision, and in IBC-TM AMVP mode, they may be performed either at integer or 4-pel precision depending on the AMVR value. Such a refinement accesses only to samples without interpolation. In both cases, the refined motion vectors and the used template in each refinement step must respect the constraint of the reference region.

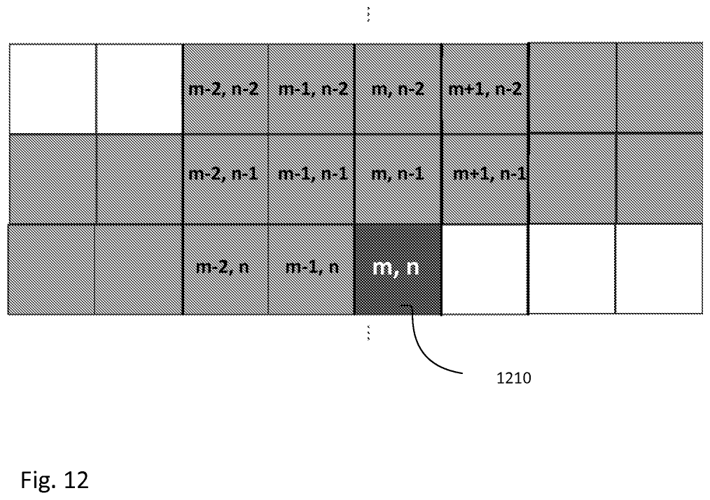

The reference area for IBC is extended to two CTU rows above. FIG. 12 illustrates the reference area for coding CTU (m,n) 1210. Specifically, for CTU (m,n) 1210 to be coded, the reference area includes CTUs with index (m−2,n−2) . . . (W,n−2), (0,n−1) . . . (W,n−1), (0,n) . . . (m,n), where W denotes the maximum horizontal index within the current tile, slice, or picture. When CTU size is 256, the reference area is limited to one CTU row above. This setting ensures that for CTU size being 128 or 256, IBC does not require extra memory in the current ETM platform. The per-sample block vector search (or called local search) range is limited to [−(C<<1), C>>2] horizontally and [−C, C>>2] vertically to adapt to the reference area extension, where C denotes the CTU size.

A Reconstruction-Reordered IBC (RR-IBC) mode is allowed for IBC coded blocks. When RR-IBC is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.

Two flip methods, horizontal flip, and vertical flip, are supported for RR-IBC coded blocks. A syntax flag is firstly signaled for an IBC AMVP coded block, indicating whether the reconstruction is flipped, and if it is flipped, another flag is further signaled specifying the flip type. For IBC merge, the flip type is inherited from neighbouring blocks, without syntax signalling. Considering the horizontal or vertical symmetry, the current block and the reference block are normally aligned horizontally or vertically. Therefore, when a horizontal flip is applied, the vertical component of the BV is not signaled and inferred to be equal to 0. Similarly, the horizontal component of the BV is not signaled and inferred to be equal to 0 when a vertical flip is applied.

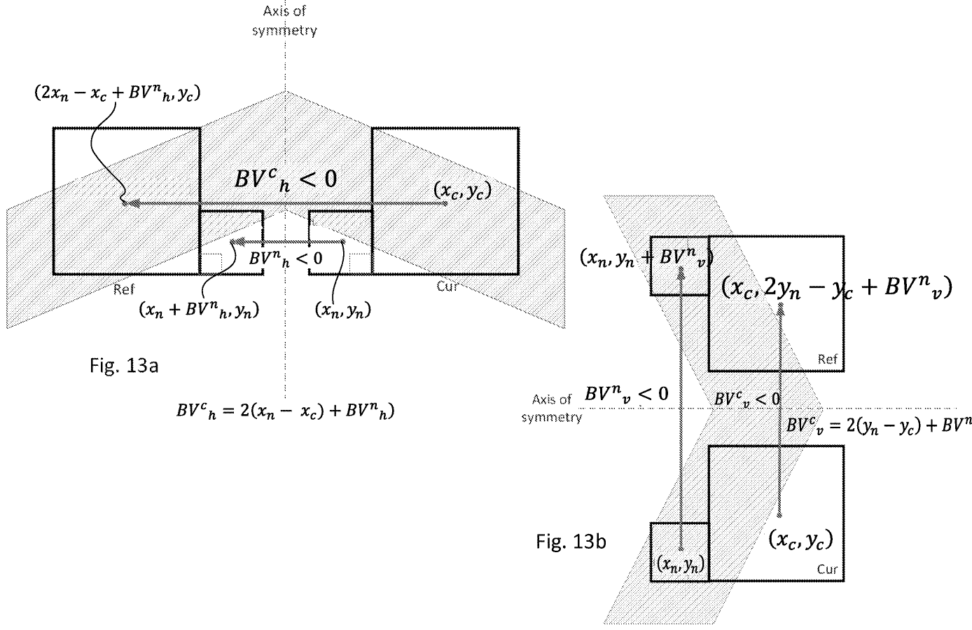

To better utilize the symmetry property, a flip-aware BV adjustment approach is applied to refine the block vector candidate. For example, as shown in FIGS. 13a and 13b, (xnbr, ynbr) and (xcur, ycur) represent the coordinates of the center sample of the neighbouring block and the current block, respectively, BVnbr and BVcur denotes the BV of the neighbouring block and the current block, respectively. Instead of directly inheriting the BV from a neighbouring block, the horizontal component of BVcur is calculated by adding a motion shift to the horizontal component of BVnbr (denoted as BVnbrh) in case that the neighbouring block is coded with a horizontal flip, i.e., BVcurh=2(xnbr−xcur)+BVnbrh. Similarly, the vertical component of BVcur is calculated by adding a motion shift to the vertical component of BVnbr (denoted as BVnbrv) in case that the neighbouring block is coded with a vertical flip, i.e., BVcurv=2(ynbr−ycur)+BVnbrv.

Affine-MMVD and GPM-MMVD have been adopted to ECM as an extension of regular MMVD mode. The MMVD mode can be extended to the IBC merge mode.

In IBC-MBVD, the distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

The base candidates may be selected from the first five candidates in the reordered IBC merge list. Based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding. The MBVD index is binarized by the rice code with the parameter equal to 1.

An IBC-MBVD coded block does not inherit flip type from a RR-IBC coded neighbor block.

Intra template matching, as shown in FIG. 10, uses the L-shaped template of the current block (R1) and a set of candidate blocks (R2, R3, R4) to find the best matching non-local block. The best matching candidate block (R2) can be used as a copy (as in IBC) to produce a prediction of the current block. However, often the copied block produces only a rough prediction and may contain sharp edges or high-frequency content resulting in poor prediction. In such cases an optimal blend of two (or more) candidate blocks may produce significantly better results.

The present embodiments are targeted to a problem as presented in the previous paragraph. Thus, the present embodiments provide a solution to obtain candidate blocks B with indices a and b, the weighting coefficient α and the bias term β, by means of which bi-weighted merge of the blocks a and b is obtained to produce a bi-weighted prediction pred of the current block as

$$pred = α * {B}_{a} + ( 1 - α ) * {B}_{b} + β ,$$

where Bₐ and B_{b} are blocks of reconstructed intra samples. A recursive variant is demonstrated for merging more than two reconstructed intra blocks. A multi-model variant is proposed for improved prediction when the model parameters themselves vary highly as a function of intensity. Additionally, a combination with other filtering-based approaches is proposed.

IBC based on intra template matching uses the L-shaped neighborhood of the current block as a template (i.e., the template comprises reconstructed samples on a top left, above and left of the current block) and finds the best non-local matching block by minimizing the error between the said template (i.e., template of the current block) and the candidate templates (i.e., templates of the candidate blocks). In the following text the term “template” refers to the L-shaped reconstructed neighborhood of a rectangular block (an example of a template 810 and a rectangular block 820 is illustrated in FIG. 8) and the set of candidate templates are L-shaped neighborhoods of non-local reconstructed blocks. Thus, the template is a set of samples surrounding the block in a L-shaped format. The error function, according to which the error can be minimized, can be, for example, sum of absolute deviations (SAD) or sum of squared errors (SSE).

From now on the discussion will be limited to templates and letter P is used to indicate a template. Subscripts will be used to differentiate between templates, i.e., Pₐ and P_{b} are two different templates corresponding to two different blocks a and b. The template of the current block is denoted as Pₜ and the N best non-local candidate templates are denoted as a set T={P₀, . . . , P_{N-1}}. The best prediction is determined by minimizing

$${‖ pred - {P}_{t} ‖}^{2} , where$$

$$pred = α * {P}_{a} + ( 1 - α ) * {P}_{b} + β$$

refers to bi-weighted merge of candidate templates Pₐ and P_{b} which belong to set T with indices a≠b. Parameters a, b, α, β are obtained using the following algorithm presented in the following pseudo-code.

```
min_error = MAX_INT;
best_alpha = 0;
best_beta = 0;
best_a = −1;
best_b = −1;
for( int i = 0; i<N−1; i++)
{
  a = i;
  Pₐ = T[i];
  for(int j=i+1; j<N; j++)
  {
    b = j;
    P_{b} = T[j];
        obtain alpha by solving equation alpha*(Pₐ−P_{b}) =Pₜ−P_{b}
    pred = alpha*Pₐ + (1−alpha)*P_{b};
    beta = mean(Pₜ−pred);
    error = sum( (pred−Pₜ+beta)*(pred−Pₜ+beta) );
    if( error < min_error )
    {
      min_error = error;
      best_alpha = alpha;
      best_beta = beta;
      best_a = a;
      best_b = b;
    }
    }
}
```

The above pseudo-code procedure outputs the parameters best_a, best_b, best_alpha, best_beta. The merging weight alpha (i.e., a) can be solved for example with simple linear regression. The predicted block will be created with the blocks corresponding to the templates best_a and best_b using the bi-weight parameters best_alpha and best_beta.

By applying a second iteration of the above search of bi-weighted model parameters (meaning both weights best_alpha, best_beta and candidates best_a, best_b) in recursive manner a prediction with three templates can be created based on the model:

$$pred = {α}_{1} * {P}_{c} + ( 1 - {α}_{1} ) * ( α * {P}_{a} + ( 1 - α ) * {P}_{b} + β ) + {β}_{1} .$$

Even further recursion is possible and is only restricted by the possible complexity constrains (e.g., runtime, number of operations) of the encoder and decoder.

A multi-model variant obtains the four parameters independently for each sample value interval. For example, with 10-bit content, (as an example) intervals I0=[0,512] and I1=[513,1023] can be set, and two sets of parameters, one set for each interval, are obtained. The number of intervals can be arbitrary and can be obtained by various means, for example by considering the mean sample value of the target template as a separator between the two intervals.

The bi-weighting approach can be combined with filtering-based approaches such as one presented by R. G. Youvalari, D. Bugdayci Sansli, P. Astola, J. Lainema, “AHG12: Filtered Template Matching based Intra Prediction (FTMP)”, JVET-AC0146. For example, each candidate in set T can be optimally filtered before deriving the bi-weighting parameters. In another example, the bi-weighted prediction can be further filtered after deriving the bi-weighting parameters.

In an embodiment the use of bi-weighted intra template matching based IBC can be signaled at CU, PU, CTU, slice, frame, or sequence level.

In an embodiment the number of candidates to merge in recursive manner can be signaled at CU, PU, CTU, slice, frame, or sequence level.

In an embodiment the use of the recursive variant can be signaled at CU, PU, CTU, slice, frame, or sequence level.

In an embodiment the number of recursions can be signaled at CU, PU, CTU, slice, frame, or sequence level.

In an embodiment the use of the multi-model variant can be signaled at CU, PU, CTU, slice, frame, or sequence level.

In an embodiment the use of the additional pre-/post-filtering of candidates can be signaled at CU, PU, CTU, slice, frame, or sequence level.

In an embodiment, the weighting can be applied non-uniformly for each sample in the block considering the spatial location of the sample within the block.

In an embodiment, the training or parameter derivation method of the weighting parameters can consider the samples' locations for optimal weight calculation.

In an embodiment, blending two or more predictions may be done in such a way that for example one prediction may be obtained using above template samples, a second prediction may be obtained using left side template samples. Then the final prediction may be obtained by blending the two predictions in such a way that samples closer to the certain template use larger weights from that prediction. For example, when blending, prediction samples obtained using above template may be assigned higher weight values for the locations closer to the above border of the block. Similarly, when blending, prediction samples obtained using left template may be assigned higher weight values for the locations closer to the left border of the block.

In an embodiment, the block vectors of the predictions that are used for blending may be stored in the memory of the codec and used later for predicting future blocks. For example, the stored block vectors may be used for candidate list generation in IBC mode.

According to previous embodiment, the block vectors may be sorted before storing them or before using them in future blocks. For example, the block vector candidates may be sorted based on the associated costs (e.g., SAD, SSE) or for example based on their distance to the block to be used, or any other methods.

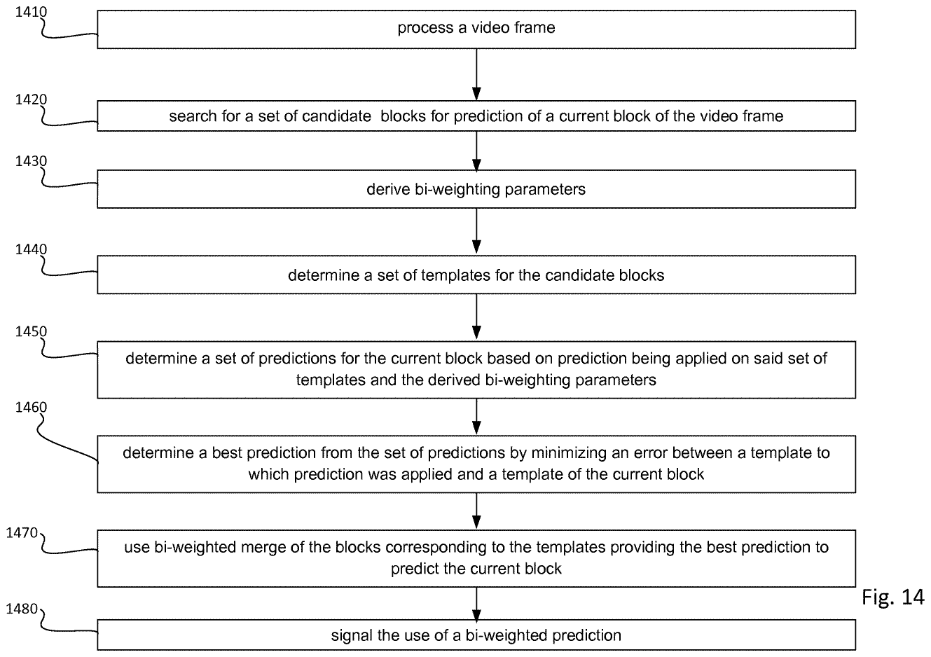

The method according to an embodiment is shown in FIG. 14. The method generally comprises processing 1410 a video frame; searching 1420 for a set of candidate blocks for prediction of a current block of the video frame; deriving 1430 bi-weighting parameters; determining 1440 a set of templates for the candidate blocks; determining 1450 a set of predictions for the current block based on prediction being applied on said set of templates and the derived bi-weighting parameters; determining 1460 a best prediction from the set of predictions by minimizing an error between a template to which prediction was applied and a template of the current block; using 1470 bi-weighted merge of the blocks corresponding to the templates providing the best prediction to predict the current block; and signaling 1480 the use of a bi-weighted prediction. Each of the steps can be implemented by a respective module of a computer system.

An apparatus according to an embodiment comprises means for processing a video frame; means for searching for a set of candidate blocks for prediction of a current block of the video frame; means for deriving bi-weighting parameters; means for determining a set of templates for the candidate blocks; means for determining a set of predictions for the current block based on prediction being applied on said set of templates and the derived bi-weighting parameters; means for determining a best prediction from the set of predictions by minimizing an error between a template to which prediction was applied and a template of the current block; means for using bi-weighted merge of the blocks corresponding to the templates providing the best prediction to predict the current block; and means for signaling the use of a bi-weighted prediction. The means comprises at least one processor, and a memory including a computer program code, wherein the processor may further comprise processor circuitry. The memory and the computer program code are configured to, with the at least one processor, cause the apparatus to perform the method of FIG. 14 according to various embodiments.

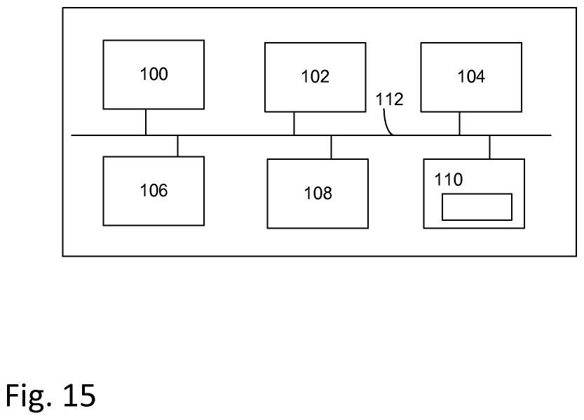

An example of a data processing system for an apparatus is illustrated in FIG. 15. Several functionalities can be carried out with a single physical device, e.g., all calculation procedures can be performed in a single processor if desired. The data processing system comprises a main processing unit 100, a memory 102, a storage device 104, an input device 106, an output device 108, and a graphics subsystem 110, which are all connected to each other via a data bus 112.

The main processing unit 100 is a conventional processing unit arranged to process data within the data processing system. The main processing unit 100 may comprise or be implemented as one or more processors or processor circuitry. The memory 102, the storage device 104, the input device 106, and the output device 108 may include conventional components as recognized by those skilled in the art. The memory 102 and storage device 104 store data in the data processing system 100.

Computer program code resides in the memory 102 for implementing, for example, a method as illustrated in a flowchart of FIG. 14 according to various embodiments. The input device 106 inputs data into the system while the output device 108 receives data from the data processing system and forwards the data, for example to a display. The data bus 112 is a conventional data bus and while shown as a single line it may be any combination of the following: a processor bus, a PCI bus, a graphical bus, an ISA bus. Accordingly, a skilled person readily recognizes that the apparatus may be any data processing device, such as a computer device, a personal computer, a server computer, a mobile phone, a smart phone, or an Internet access device, for example Internet tablet computer.

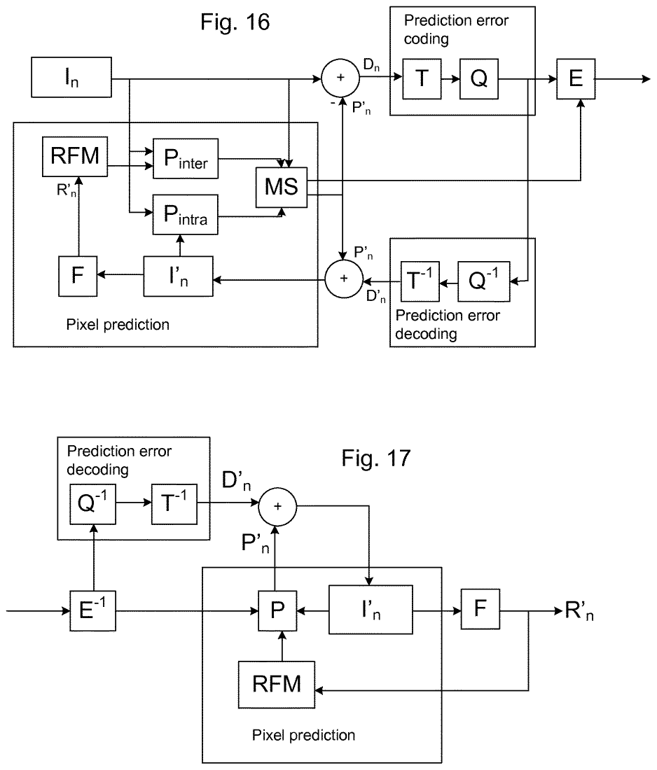

FIG. 16 illustrates an example of a video encoder, where Iₙ: Image to be encoded; P′ₙ: Predicted representation of an image block; Dₙ: Prediction error signal; D′ₙ: Reconstructed prediction error signal; I′ₙ: Preliminary reconstructed image; R′ₙ: Final reconstructed image; T, T⁻¹: Transform and inverse transform; Q, Q⁻¹: Quantization and inverse quantization; E: Entropy encoding; RFM: Reference frame memory; Pᵢₙₜₑᵣ: Inter prediction; Pᵢₙₜᵣₐ: Intra prediction; MS: Mode selection; F: Filtering. FIG. 17 illustrates a block diagram of a video decoder where P′ₙ: Predicted representation of an image block; D′ₙ: Reconstructed prediction error signal; I′ₙ: Preliminary reconstructed image; R′ₙ: Final reconstructed image; T⁻¹: Inverse transform; Q⁻¹: Inverse quantization; E⁻¹: Entropy decoding; RFM: Reference frame memory; P: Prediction (either inter or intra); F: Filtering. An apparatus according to an embodiment may comprise only an encoder or a decoder, or both.

The various embodiments can be implemented with the help of computer program code that resides in a memory and causes the relevant apparatuses to carry out the method. For example, a device may comprise circuitry and electronics for handling, receiving, and transmitting data, computer program code in a memory, and a processor that, when running the computer program code, causes the device to carry out the features of an embodiment. Yet further, a network device like a server may comprise circuitry and electronics for handling, receiving, and transmitting data, computer program code in a memory, and a processor that, when running the computer program code, causes the network device to carry out the features of various embodiment.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1-16. (canceled)

17. An apparatus, comprising at least one processor, memory including computer program code, the memory and the computer program code configured to, with the at least one processor, cause the apparatus to perform at least the following:
processing a video frame;
searching for a set of candidate blocks for prediction of a current block of a video frame;
deriving bi-weighting parameters;
determining a set of templates for the candidate blocks;
determining a set of predictions for the current block based on prediction being applied on said set of templates and the derived bi-weighting parameters;
determining a best prediction from the set of predictions by minimizing an error between a template to which prediction was applied and a template of the current block; and
using bi-weighted merge of the blocks corresponding to the templates providing the best prediction to predict the current block.

18. The apparatus according to claim 17, wherein the candidate blocks are searched from a reconstructed part of the current frame.

19. The apparatus according to claim 17, wherein the candidate blocks, and the current block have an L-shaped template.

20. The apparatus according to claim 17, wherein the set of candidate blocks comprises two or more reconstructed intra blocks.

21. The apparatus according to claim 20, wherein when the set of candidate blocks comprise more than two reconstructed intra blocks, the apparatus comprises means for merging the more than two reconstructed intra blocks.

22. The apparatus according to claim 17, wherein the instructions, when executed by the at least one processor, cause the apparatus to perform at least filtering each candidate block in a set of candidate blocks.

23. The apparatus according to claim 22, wherein the instructions, when executed by the at least one processor, cause the apparatus to perform at least signalling or receiving an indication of a use of filtering at coding unit, prediction unit, coding tree unit, slice, frame, sequence level.

24. The apparatus according to claim 17, wherein the instructions, when executed by the at least one processor, cause the apparatus to perform at least signalling or receiving indication of the use of the bi-weighted prediction at coding unit, prediction unit, coding tree unit, slice, frame, sequence level.

25. The apparatus according to claim 17, wherein the instructions, when executed by the at least one processor, cause the apparatus to perform at least further comprising deriving the bi-weighting parameters in a recursive manner.

26. The apparatus according to claim 25, wherein the instructions, when executed by the at least one processor, cause the apparatus to perform at least signaling or receiving an indication of a number of candidate blocks to merge in recursive manner at coding unit, prediction unit, coding tree unit, slice, frame, sequence.

27. The apparatus according to claim 25, wherein the instructions, when executed by the at least one processor, cause the apparatus to perform at least signalling or receiving an indication of a use of recursive search at coding unit, prediction unit, coding tree unit, slice, frame, sequence level.

28. The apparatus according to claim 25, wherein the instructions, when executed by the at least one processor, cause the apparatus to perform at least signalling or receiving indication of a number of recursions at coding unit, prediction unit, coding tree unit, slice, frame, sequence level.

29. The apparatus according to claim 17, wherein the instructions, when executed by the at least one processor, cause the apparatus to perform at least deriving the bi-weighting parameters by a multi-model variant where a set of parameters is obtained for a sample value interval.

30. The apparatus according to claim 29, wherein the instructions, when executed by the at least one processor, cause the apparatus to perform at least signalling or receiving an indication of a use of multi-model variant at coding unit, prediction unit, coding tree unit, slice, frame, sequence level.

31. A method comprising:
processing a video frame;
searching for a set of candidate blocks for prediction of a current block of the video frame;
deriving bi-weighting parameters;
determining a set of templates for the candidate blocks;
determining a set of predictions for the current block based on prediction being applied on said set of templates and the derived bi-weighting parameters;
determining a best prediction from the set of predictions by minimizing an error between a template to which prediction was applied and a template of the current block; and
using bi-weighted merge of the blocks corresponding to the templates providing the best prediction to predict the current block.

32. A non-transitory computer readable medium comprising instructions which, when executed by an apparatus, cause the apparatus to perform at least the following:
processing a video frame;
searching for a set of candidate blocks for prediction of a current block of the video frame;
deriving bi-weighting parameters;
determining a set of templates for the candidate blocks;
determining a set of predictions for the current block based on prediction being applied on said set of templates and the derived bi-weighting parameters;
determining a best prediction from the set of predictions by minimizing an error between a template to which prediction was applied and a template of the current block; and
using bi-weighted merge of the blocks corresponding to the templates providing the best prediction to predict of the current block.

33. An apparatus according to claim 17, wherein the instructions, when executed by the at least one processor, cause the apparatus at least to signal the use of a bi-weighted prediction in or along with a bitstream.

34. An apparatus according to claim 17, wherein the instructions, when executed by the at least on processor, cause the apparatus at least to receive an indication of weighted prediction from or along with a bitstream.
